(19) United States
(12) Patent Application Publication
(10) Pub. No.: US 2011/0317879 A1
(43) Pub. Date: Dec. 29, 2011

(54) Measurement of Positional Information for a Robot Arm

(75) Inventor: Andreas Haralambos Demopoulos, Bedfordshire (GB)

(73) Assignee: ABSOLUTE ROBOTICS LIMITED, Bedfordshire (GB)

(21) Appl. No.: 13/201,453

(22) PCT Filed: Feb. 16, 2010
(86) PCT No.: PCT/GB2010/050249

§ 371 Date: Sep. 7, 2011

(30) Foreign Application Priority Data
Feb. 17, 2009 (GB) 09026253
Oct. 19, 2009 (GB) 09182452

(51) Int. Cl. G06K 9/00

(52) U.S. Cl. 382/106

(57) ABSTRACT

Positional measurements for a robot arm are made using a light ray projector (10) mounted on the robot arm and arranged to emit light rays (50) along a multiplicity of distinct paths that are fixed relative to the projector (10), and a removable support frame (20) carrying a multiplicity of image sensors (22) at fixed positions relative to the support frame (20), the support frame surrounding the base of the robot arm. A signal processor (25) connected to the light sensors (22) determines the positions at which light rays (50) are incident on the image sensors (22), and hence determines positional information of a system of axes associated with the projector (10) relative to the frame (20). This enables relative positional measurements to be made substantially in real time, and in an accurate and cost-effective manner.

The present invention relates to a method of determining the position and orientation of a robot arm, or more generally of two or more systems of axes relative to one another, and for establishing the positions and orientations of two or more objects relative to each other, provided that the relationship between the objects and the two systems of axes are known; the invention also relates to an apparatus for performing such measurements.

Currently, there are two widely used methods for non-contact measurements: using a laser tracker, and photogrammetry. The former works on a spherical co-ordinate system by measuring the two angles and the distance of a reflected light beam between the source and a retroreflector placed on the object to be measured. Photogrammetry utilises cameras, optionally with a fixed or scanning light beam, to measure an object's position based on well established stereo and laser triangulation principles.

In many applications we are interested in measuring small changes to an object's position and orientation due to vibrations, thermal expansions, static or dynamic deflection due to applied loading, or indeed due to any other causes. A laser tracker is an accurate instrument, but may be too expensive and too sensitive. These attributes preclude the use of laser trackers from many industrial applications. A photogrammetry based system also suffers from limitations, as although measurements can be acquired in real time, their accuracy may not be sufficient, especially if small positional changes are to be measured over large distances. In addition, multiple measurements can result in chain errors that significantly degrade the accuracy of the final measurement. Bearing in mind that photogrammetry based systems can be expensive too, their use is precluded from many applications where the highest accuracy over large distances is required.

According to the present invention there is provided an apparatus for making positional measurements of a robot arm, the apparatus comprising a light ray projector arranged to emit light rays along a multiplicity of distinct paths that are known relative to the projector, the projector being mounted on the robot arm; a support frame carrying a multiplicity of image sensors at fixed positions relative to the support frame; and means connected to the light sensors to determine the positions relative to the support frame at which light rays are incident on the image sensors, and hence to determine positional information of a system of axes associated with the projector relative to the support frame.

The present invention also provides a method for making positional measurements, using such a light ray projector and such a frame carrying image sensors. The term light ray means a narrow beam of radiation, preferably visible light (although ultraviolet or infra-red radiation may also be suitable, with a suitable sensor), like that from a laser; and preferably the width of the light ray at a distance of 1 m from the projector is no more than 15 mm, more preferably no more than 10 mm and more preferably no more than 3 mm; the width of the light ray should preferably be less than the width of the image sensor.

The positions at which the light rays are incident on the image sensors can be readily measured relative to a system of axes fixed relative to the frame, while the paths of the light rays are in known positions relative to a system of axes fixed relative to the light ray projector. The present invention enables the position and orientation of the two systems of axes to be measured relative to one another. In general, both systems of axes could be moving, or one fixed and the other moving. By extension, this concept can be used to establish the positions and orientations of two or more objects relative to each other, provided that the relationship between the objects and the two systems of axes are known. Furthermore, the concept could be extended to establish positional relationships between multiple sets of axes and multiple objects related to those axes.

The light rays may be produced by a multiplicity of light sources, or alternatively by a single light source whose light is split or directed to follow the multiplicity of light ray paths. For example each light ray may be a light beam emitted by a laser diode. There must be at least three different paths along which light rays travel, but there may be at least ten light ray paths, for example the light ray projector may transmit at least twenty. There may indeed be more than a hundred such light rays. The light rays may all be transmitted simultaneously. Alternatively the light rays along different paths may be produced sequentially. Hence as an alternative a single light source can be sequentially directed along different paths which are in known relative positions. For example a single light source may be supported by means that allow it to be pivoted about two different axes through known angles. Such a single light source may be substantially similar to a laser tracker, but without the facility for distance measurement.

The imaging sensors are pixelated imaging sensors analogous to those used in digital cameras, but without an associated lens, so they may for example be charge-coupled devices (CCDs) or complementary metal-oxide-semiconductor (CMOS) active-pixel sensing device; and such a device may be referred to as an imaging chip. Although they are referred to as imaging sensors, they are not used to obtain an image, but only to determine positions.

When a light ray is incident on an image sensor, it produces an illumination spot which may cover several pixels, depending on the width of the light ray. The centre of the light spot may be found using conventional image processing techniques, for example based on a weighted average of the intensities at the different pixels that are above a threshold. Under some circumstances at least some of the image sensors may comprise a plurality of such imaging chips placed next to each other, so that larger displacements of one object relative to the other can be monitored without the light spots moving off the surface of the image sensors.

Indeed a substantial proportion of the surface of the frame may be entirely covered in such imaging chips, even if the surface is curved, so that large movements of the light spots can be monitored.

For calibration purposes both the light ray projector and the support frame preferably incorporate optical reference elements, or means to support optical reference elements, which are used during calibration of the apparatus. These optical reference elements may comprise spherically mounted retroreflectors, suitable for use with a laser scanner, such a retroreflector consisting of an accurately-made sphere with a recess defined by three mutually-orthogonal surfaces that intersect precisely at the centre of the sphere. Such a retroreflector may be mounted into a conical holder, which may be magnetic, and the sphere can then be rotated to pick up an incident light beam while the centre of the sphere remains at the same place.

The invention hence enables relative, 6-degree-of-freedom measurements to be made that are highly accurate, yet the method uses non-contact measurements, and in some cases measurements can be acquired in real time. The apparatus can be robust, and can be comparatively inexpensive, as all the components are readily available.

The invention will now be further and more particularly described by way of example only, and with reference to the accompanying drawings, in which:

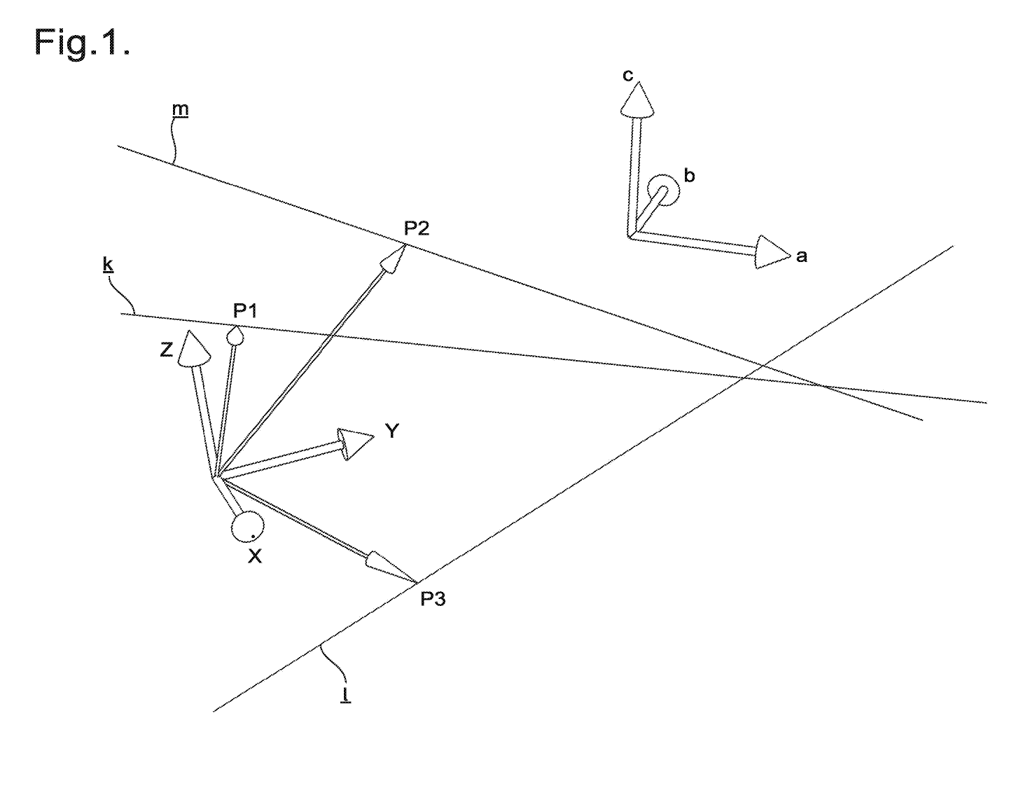

FIG. 1 shows a diagram of the mathematical principle on which operations of the apparatus is based;

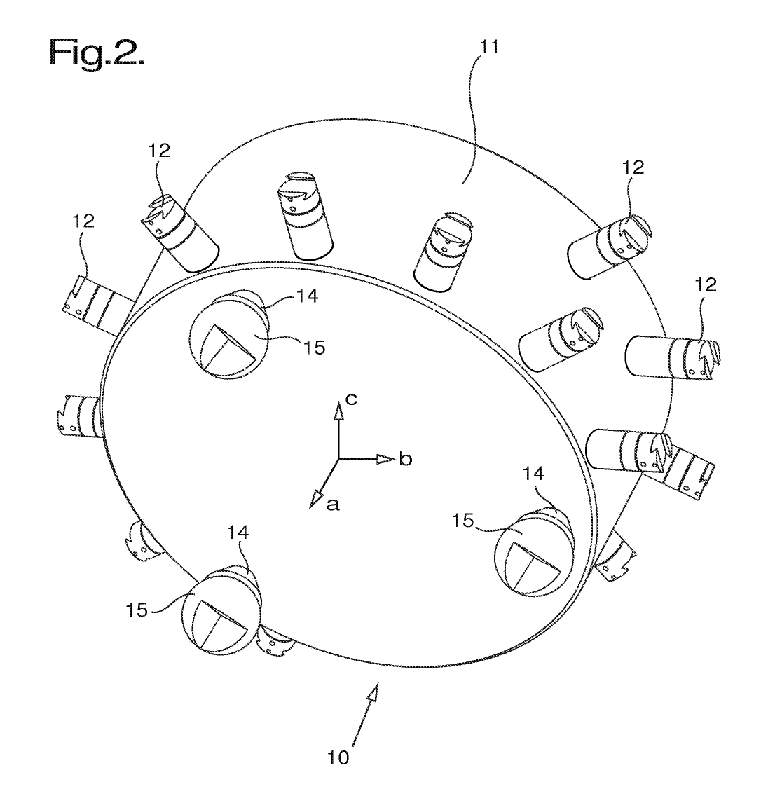

FIG. 2 shows a perspective view of a light ray projector for use in the invention;

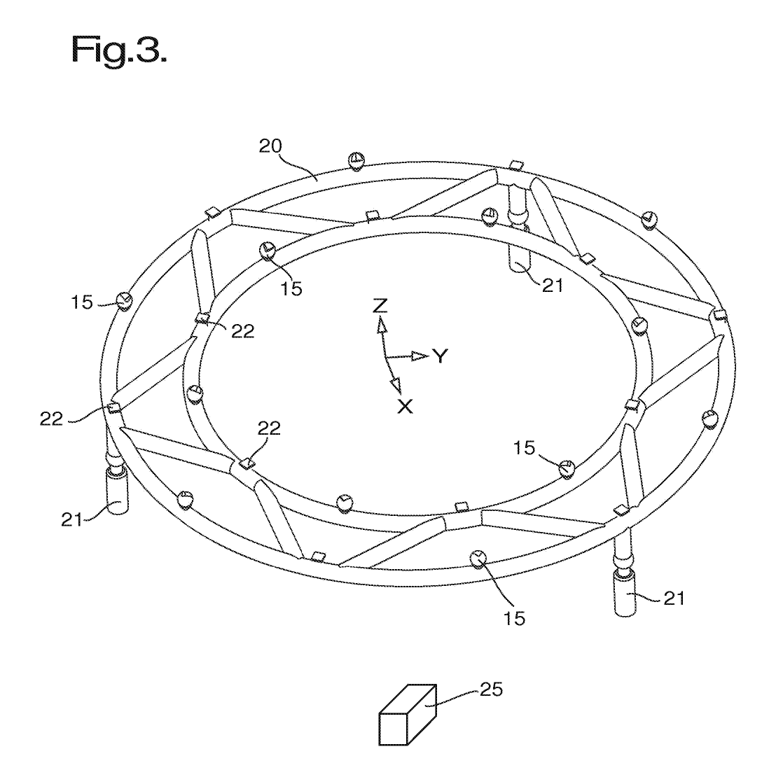

FIG. 3 shows a perspective view of a support ring for use in the invention;

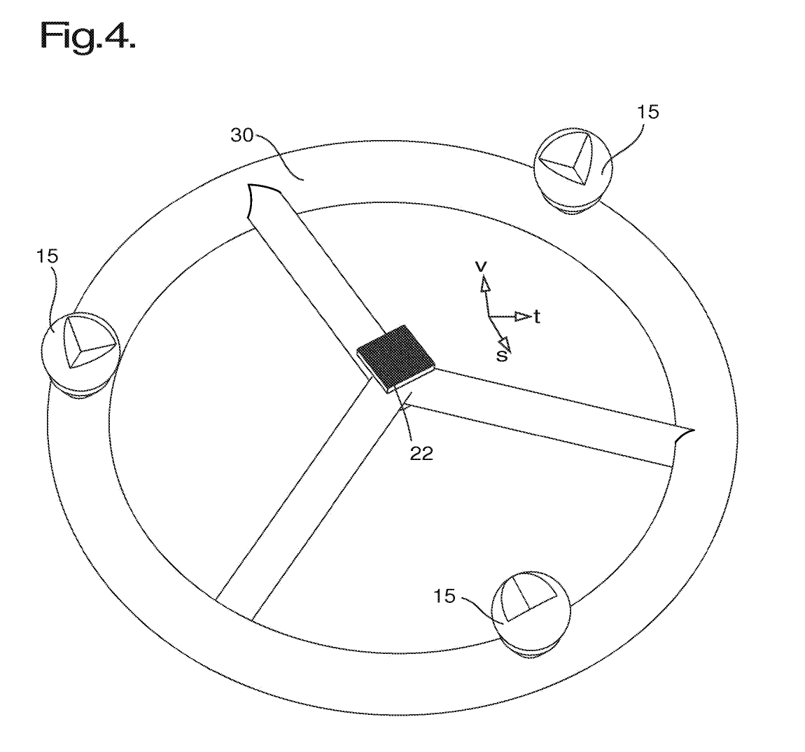

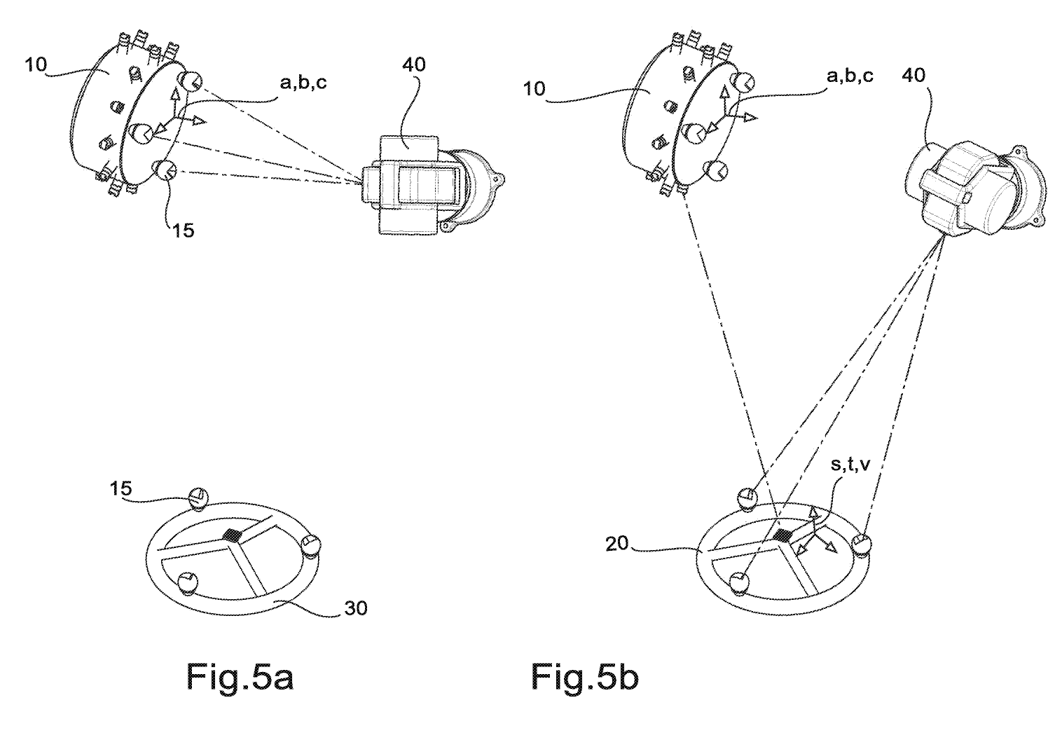

FIG. 4 shows a perspective view of a calibration ring for use in calibrating the projector of FIG. 2; FIGS. 5a and 5b show perspective views of use of the calibration ring of FIG. 4;

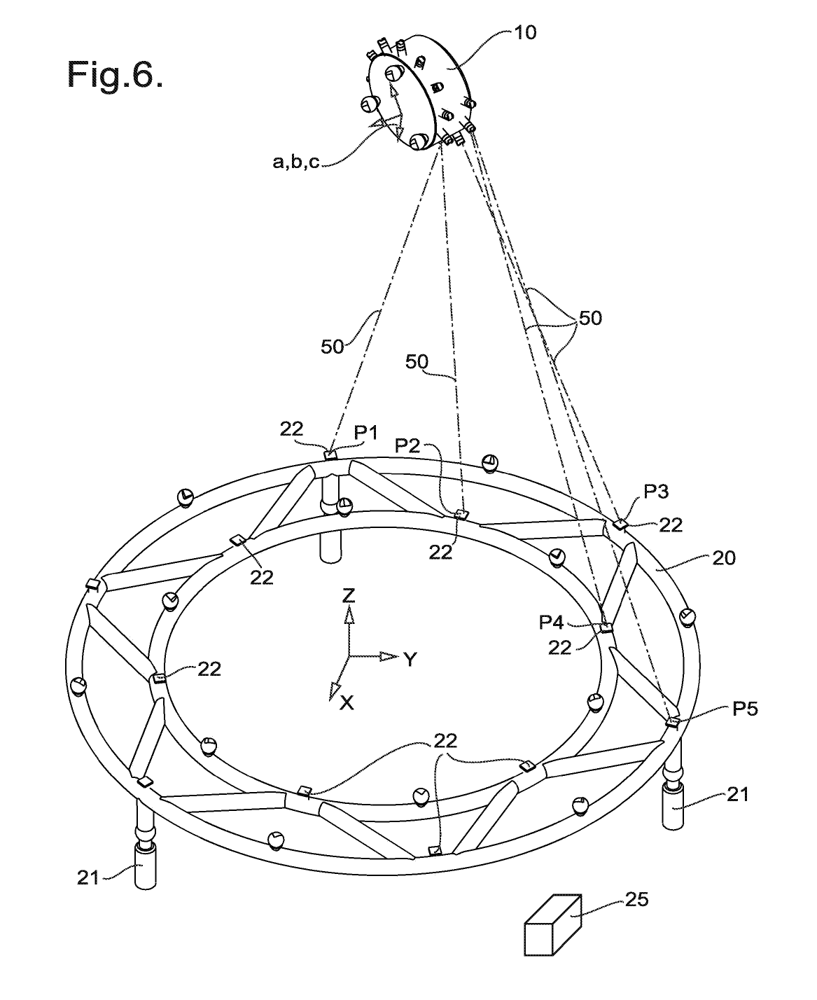

FIG. 6 shows a perspective view of the light ray projector of FIG. 2 and the support ring of FIG. 3, during use of the apparatus;

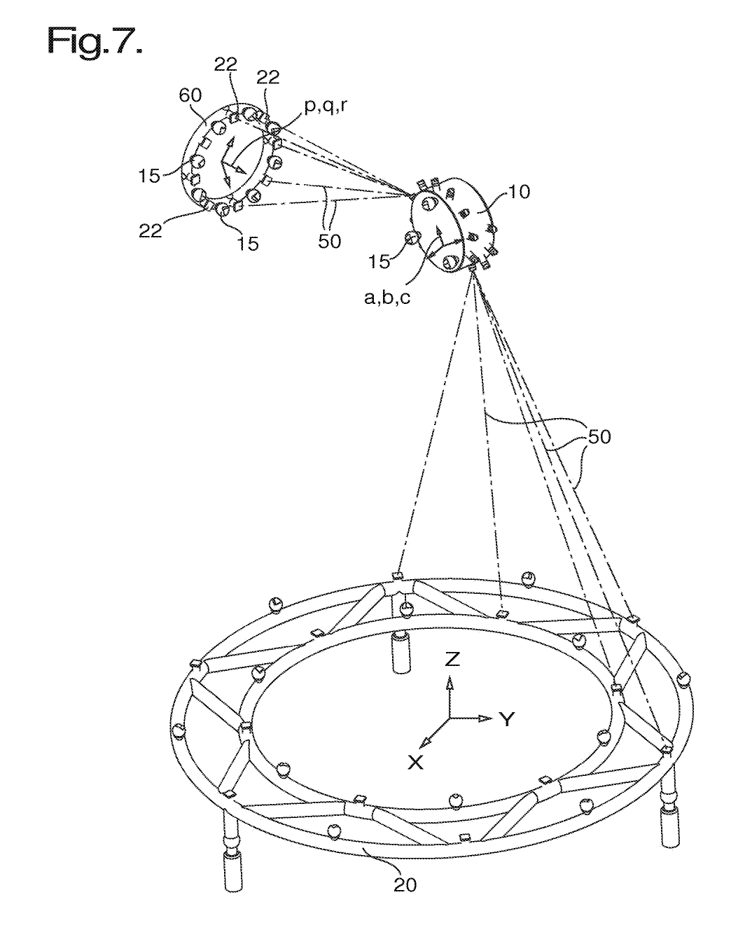

FIG. 7 shows a perspective view, similar to FIG. 6, during an alternative use of the apparatus; and

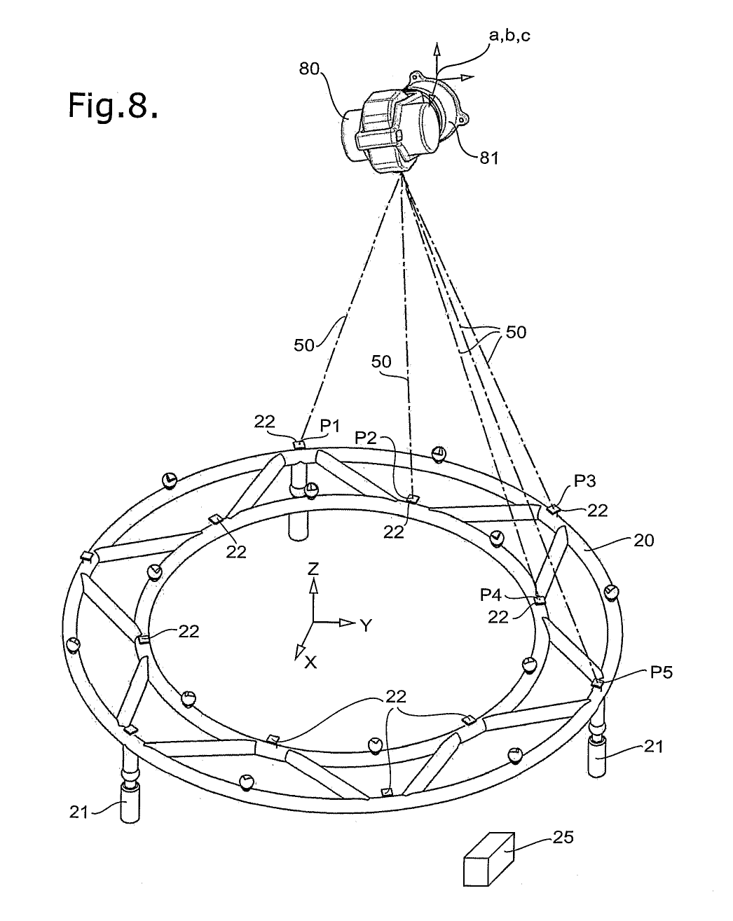

FIG. 8 shows a modification to the apparatus shown in FIG. 6.

Referring to FIG. 1, the invention relates to a context in which there are two systems of axes. In this example each of the systems of axes, XYZ and abc, consists of orthogonal axes, although orthogonal axes are not essential to the invention. There are three non-colinear lines k, l and m, whose equations are known with respect to the abc system of axes. These lines are therefore fixed with respect to one another and with respect to the abc system of axes. There are three points P1, P2 and P3 whose position vectors are known with respect to the XYZ system of axes. Under these circumstances, if the points P1, P2 and P3 lie anywhere on the lines k, l and m, then the position and orientation of the two systems of axes XYZ and abc can be determined relative to each other.

### 1. The Apparatus

In the present invention the lines k, l and m, are replaced by optical rays generated by a light ray projector. One such light ray projector 10 is shown in FIG. 2, to which reference is now made. In this example the light ray projector 10 comprises a housing 11 of generally cylindrical shape, with several laser diodes 12 mounted around its cylindrical surface so as to emit light rays in several different fixed radial directions (thirteen are shown). On an end face of the housing 11 are mounted three magnetic conical receptors 14 which locate three spherically mounted retroreflectors (SMRs) 15. These retroreflectors enable the position of the projector 10 in space to be determined with a high degree of accuracy using a laser tracker. Instead of using several separate light sources (the laser diodes 12) there might instead be fewer light sources, or just one light source, whose light is split to form multiple beams in different fixed directions.

In some situations it is desirable to be able to distinguish simply and automatically between the light rays emitted by the different laser diodes 12, and this may for example be done by pulsing each light ray with a different code. In other situations, where the position of the light ray projector 10 is already known at least approximately, the light rays may be distinguishable by virtue of their direction of propagation.

The present invention also requires a frame. A suitable frame is shown in FIG. 3, to which reference is now made, which in this example is in the form of a thermally and mechanically stable support ring 20 that is made from low expansion material such as INVAR™ or NILO 36™ and which, in its home position, rests on fixed legs 21 (when in this position it may be referred to as the base ring). For measurements on a robot arm (not shown), the ring 20 would surround the base of the robot arm. A number of SMRs 15 locate in receptors 14 (as shown in FIG. 2) attached to the support ring 20. These retroreflectors have three mutually orthogonal surfaces that intersect precisely at the centre of the sphere. A light ray striking any of those surfaces is reflected back along its incident direction. The spherical surface of each SMR 15 is mounted into a conical receptor 14 so each SMR 15 can be rotated in different directions to pick up an incident ray while the centre of the sphere remains at the same place. In addition to the SMRs 15, a number of imaging sensors 22 (CCDs, CMOS or other type) are also mounted onto the support ring 20, together with the associated hardware and software that is required to acquire the images on those sensors 22, for example in the form of a signal processing unit 25 connected to all the sensors 22. (Each such sensor 22 can be perceived as a normal digital camera but without any lens system.)

### 2. Setting up the Apparatus

Before measurements can be made using the apparatus of the invention, both the light ray projector 10 and the support ring 20 must first be calibrated.

### 2.1 Establishing the Reference System of Axes XYZ and Calibrating the Imaging Sensors 22

After manufacture, the ring 20 is placed on a Coordinate Measuring Machine (CMM) and the centres of the SMRs 15 are determined by the three mutually orthogonal planes on each SMR 15. An XYZ system of axes can be established by conventional means from the known centres of all the SMRs 15 on the support ring 20. Although this may be performed using a contacting probe, a non-contact optical scanner (which combines a point laser beam with a camera system) is preferred, as this is required for the calibration of the sensors 22. Such a scanner forms part of a conventional CMM. The three orthogonal planes of the SMRs 15 are scanned first to establish the centres of the SMRs 15 on the ring 20, and so to relate measurements of the optical scanner to an XYZ system of axes.

The point laser beam of the optical scanner is then used to scan all the imaging sensors 22 in turn. The beam from the optical scanner forms, in each case, a light spot at the top surface of the imaging sensor 22. The centre of this spot, in relation to the pixels of the imaging sensor 22, is located to sub-pixel accuracy using conventional imaging processing techniques, for example based on a weighted average of pixel intensities above a given threshold. In this way a relationship is established between the centres of the illuminating spots in the pixel co-ordinate system of each sensor 22, and their corresponding coordinates in the XYZ reference system of axes as measured by the optical scanner. By interpolating between the calibrated positions we can establish a relationship for all points on the imaging sensors 22.

### 2.2 Calibrating the Light Ray Projector 10

The equations of the optical rays must be established with respect to a suitable system of axes, in order to calibrate the light ray projector 10. This can be accomplished using a calibration ring 30 as shown in FIG. 4, to which reference is now made. This calibration ring 30 is similar to the support ring 20 but considerably smaller: in this case it carries only three SMRs 15 and one imaging sensor 22. More SMRs 15 and imaging sensors 22 could be attached to the calibration ring 30 if required to make it more versatile.

The imaging sensor 22 on the calibration ring 30 is first calibrated against a system of axes stv defined in relation to the centres of the SMRs 15 on the calibrating ring 30. This is equivalent to the process described in section 2.1 for the support ring 20.

The light ray projector 10 is then set up in a fixed position, so it is stationary. As shown in FIG. 5a, a fixed laser tracker 40 may then be used to locate the SMRs 15 on the stationary light ray projector 10. The abc system of axes may be defined relative to these SMRs 15, and so in a known relationship to the light ray projector 10.

For a chosen optical ray, the calibration ring 30 is placed successively at a number of different positions along the ray, ensuring in each case that the ray hits the imaging sensor 22 on the calibration ring 30 and forms a light spot. The centre of this spot is determined to sub-pixel accuracy by conventional imaging processing techniques such as the weighted average of pixel intensity distribution above a given threshold. Since the imaging sensor 22 is calibrated, the centre of this spot is known with respect to the stv system of axes of the calibration ring 30. For each successive position of the calibration ring 30 along the light ray, the laser tracker 40 is used to locate the centres of the SMRs 15 on the calibration ring 30, as shown in FIG. 5b. This process enables the stv system of axes, and hence the centre of the light spot, to be related to the abc system of axes associated with the light ray projector 10. In this way we obtain the coordinates of several points along the selected ray, and hence the equation of the ray with respect to the abc system of axes. The above process is repeated for all rays of the optical ray generator so the equations of all rays are obtained with respect to the same abc system of axes.

### 2.2.1 Modifications to the Calibration of the Light Ray Projector 10

In a first alternative the support ring 20 of FIG. 3 may be used instead of the calibration ring 30 in the calibration procedure described in section 2.2, moving the support ring 20 successively to a number of different positions along each light ray, and ensuring in each case that the ray hits an imaging sensor 22 on the support ring 20 and forms a light spot. This has the benefit of avoiding the need to make a separate calibration ring 30, although in this example the support ring 20 is considerably larger and more cumbersome than the calibration ring 30. Since the support ring 20 carries several imaging sensors 22, it may be possible to use it to calibrate more than one ray at once.

In a second alternative the fixed laser tracker 40 is not used to locate the SMRs 15 on the stationary light ray projector 10. In this case the equations of the paths followed by the light rays are determined with respect to a system of axes abc that are in a fixed position relative to the laser tracker 40 during the calibration step; during subsequent use the equations of the paths followed by the light rays are known with respect to a system of axes abc whose origin is in a fixed but unknown position relative to the light ray projector 10. (This may be subsequently referred to as a virtual system of axes.)

### 3. Operation of the Apparatus

Referring now to FIG. 6, the apparatus consisting of the light ray projector 10 and the ring 20 can then be used to monitor the position of an object, for example a robot arm or a crane. The support ring 20, which is removable, may be installed at its home position resting on the legs 21, so that the XYZ system of axes is fixed relative to the working space; it may therefore be called the base ring. The support ring 20 is large enough to surround the base of the robot arm (not shown), for example being of inner diameter more than 1 m.

The light ray projector 10 is mounted on the object whose position is to be monitored, which is a robot arm in this example. For a given position of the light ray projector 10 (and so of the robot arm), some imaging sensors 22 on the base ring 20 will be hit by some light rays 50 (shown diagrammatically). A minimum of three rays 50 are required. Additional intersecting rays 50 provide redundant measurements that increase the overall measurement accuracy of the apparatus. The coordinates of the centres of the light spots on the imaging sensors 22 are determined using the same weighted average of pixel intensity distribution as the one employed during the ray equation procedure. The coordinates of these centre points are equivalent to position vectors such as P1, P2 and P3 in FIG. 1, relative to the established XYZ system of axes on the base ring 20, and are marked as P1-P5 in FIG. 6.

Since the equations of the lines followed by these light rays 50 are known, relative to the axes abc, as deduced above under section 2.2, the relationship between the axes abc and XYZ can be calculated, and so the position of the light ray projector 10 can therefore be accurately measured relative to the XYZ system of axes. Hence the signal processing unit 25 can calculate the position of the light ray projector 10 using conventional mathematical transformations, and so that of the robot arm to which it is mounted.

It will be appreciated that there is no requirement for the support ring 20 to be in a fixed position. In some situations both the support ring 20 and the light ray projector 10 may be movable, and it is still the case that the position of the light ray projector 10 can be measured relative to the XYZ system of axes that is fixed relative to the support ring 20, but the XYZ system of axes need not be fixed relative to the working space. It will also be appreciated that as an alternative, the support ring 20 may be attached to the object, and the light ray projector 10 mounted in a fixed position. The procedure is substantially identical, except that in this case the position of the ring 20 and therefore the object are accurately measured relative to the abc system of axes.

In either case it will be appreciated that the attachment of the light ray projector 10 or the support ring 20 on to the object should be stress free, and must allow no relative movement. Existing types of magnetic couplings are well suited for this purpose.

If the object to be measured has some features of interest, the position of those features must be established beforehand with respect to the abc or the XYZ system of axes, depending on which part is attached to the object to be measured. As the origin of those systems of axes is related to the centres of SMRs 15 attached to the component mounted on the object, it is fairly easy to establish this relationship because the SMRs are physical objects that can be scanned or located by a touch/optical probe or laser tracker.

It will be appreciated that although the laser scanner 40 is used during calibration of the apparatus, it is not required during subsequent use, so that the invention provides a significantly cheaper measurement technique, which can take measurements considerably more rapidly but with a similar accuracy. Thus the invention makes use of the principle described in relation to FIG. 1. The light rays 50 whose equations are known relative to a system of axes abc correspond to the straight lines k, l and m, while the positions of the light spots where the light rays 50 hit the imaging sensors 22 on the support ring 20, which are known relative to the axes XYZ, correspond to the positions P1, P2 and P3. Hence the position and orientation of the system of axes abc can be related to the system of axes XYZ. And if the position of the origin of the system of axes abc is known relative to the light ray projector 10, then the position of the light ray projector 10 can also be determined relative to the axes XYZ.

### 4. Alternatives and Modifications

It will be appreciated that the measurement procedure described above is given by way of example only, and that the apparatus and procedure may be modified in various ways, while remaining within the scope of the present invention. For example:

a) The function of the light ray projector could be integrated with that of the support ring. For example, the light ray projector 10 could be fitted with imaging sensors 22 (like those fitted to the support ring 20), in addition to the light ray emitters; and equally the support ring 20 could be fitted with light ray emitters, in addition to the imaging sensors 22.
b) If, as mentioned above, the fixed laser tracker 40 was not used to locate the SMRs 15 on the stationary light ray projector 10 during the calibration step to establish the equations of the paths followed by the light rays, then the origin of the system of axes abc is at a fixed but unknown position relative to the light ray projector 10. With such a “virtual” system of axes abc it is not possible to deduce the position of the light ray projector 10, nor to deduce the position of the robot arm to which it is attached. Nevertheless any changes in the position or orientation of the robot arm and of the light ray projector 10 can readily be measured, as they correspond to a change in the position or orientation of the virtual system of axes abc.
c) FIG. 7 shows an application where the position and orientation of a robot arm is measured indirectly as a two step process. In this case the 6-D measurement apparatus consists of three parts: the support ring 20 that is mounted in a stationary position surrounding the base of the robot arm; the light ray projector 10; and a secondary ring 60. The projector 10 and a secondary ring 60 would be attached at different positions along the robot arm. The secondary ring 60 is substantially equivalent to the support ring 20, consisting of a thermally and mechanically stable ring that carries both imaging sensors 22 and SMRs 15, although in this example it is of a smaller diameter. In this example the support ring 20 acts as a base ring, being at a fixed position, while the light ray projector 10 and the secondary ring 60 may move relative to each other and relative to the base ring 20.

The secondary ring 60 defines its own system of axes pqr that is established from the centres of the SMRs 15 attached to it. The same method is used as the one described in section 2.1, and the imaging sensors 22 on the secondary ring 60 are calibrated against the pqr reference system of axes in the same way as described in section 2.1.

We are now in a position to determine the position and orientation of the secondary ring 60, and so of that part of the robot arm to which the secondary ring 60 is attached, with respect to the system of axes XYZ associated with the base ring 20, as a two step process.

In the first step the position and orientation of the system of axes pqr is established relative to the abc system of axes in which the equations of the light rays 50 are known. In the second step the position and orientation of the abc system of axes is determined relative to the fixed system of axes XYZ, based on the base ring 20. Since all the measurements involved are optical measurements and they can be acquired simultaneously, it follows that the position and orientation of the secondary ring 60 and any object to which the secondary ring 60 is attached can be determined with high accuracy and in real time relative to the XYZ system of axes. It will also be appreciated that in this indirect measurement system the actual position of the light ray projector 10 relative to the system of axes abc is irrelevant, so that the abc system of axes may be a “virtual” system of axes as discussed above.

By way of example this two step process could be applied to measure the position and orientation of the 4^{th} axis of a robot arm. In this case the removable base ring 20 would be placed around the base of the robot arm, the light ray projector 10 being attached at an intermediate position along the robot arm, and the secondary ring 60 being attached to the 4^{th} axis of the robot, preferably being coaxial with it. The position of the secondary ring 60 and hence that of the 4^{th} axis of the robot can in this way be measured with respect to the stationary base ring 20 that defines the absolute frame of reference XYZ. This measurement is possible for any discrete configurations of the robot at which light rays 50 from the projector 10 are incidental on at least three imaging sensors 22 on each of the secondary and base rings 60 and 20. It will be appreciated that the secondary ring 60 could be attached to any part of the robot, not just the 4^{th} axis, without changing the principle of the measurements.

As another example this two step process could be applied to measure any movement of a component of a vehicle relative to the vehicle chassis, by mounting the support ring 20 on the chassis and mounting the secondary ring 60 on the relevant component, and mounting the light ray projector 10 at a position on the vehicle from which both the support ring 20 and the secondary ring 60 are visible. In this case the movements of the secondary ring 60 are monitored relative to the support ring 20 by the two step process described above, even though neither component is fixed relative to an external absolute frame of reference.

d) The procedures described above make use of a light ray projector 10 that can produce light rays along several different paths 50 simultaneously. As an alternative the light rays can instead be generated successively by a single light source which is steered in a controlled manner into different but known orientations; this is described in more detail in the following section.

### 5. Description of Steerable Light Ray Projector

Referring now to FIG. 8, an alternative system is shown in which light rays 50 along different paths are generated using a scanner 80 with a single light source, such as a laser, supported such that it can be rotated about two axes. These axes are preferably orthogonal; in general they can be skew and non-coplanar. Both axes are motorised, and have associated high accuracy angular encoders to provide positional information. The path of the light ray 50 from the scanner 80 may therefore be controlled by a signal processing unit 25 to which the scanner 80 is connected.

The scanner 80 is similar to the laser tracker 40 mentioned earlier, but without the facility for distance measurement. That is to say the scanner 80 can produce light rays along a multiplicity of different paths 50 in succession, and these paths 50 are known relative to a local set of axes abc fixed relative to the base 81 of the scanner 80. That is to say the equations of each path 50 are known relative to the local axes abc, by virtue of readings from the angular encoders.

In this case the scanner 80 may be steered so as to transmit light rays 50 successively onto a plurality of the imaging sensors 22. Since, as described above, the exact positions P1, P2 etc at which the light rays 50 intersect the imaging sensors 22 are known relative to the axes XYZ, it follows that the relationship between the axes abc and XYZ can be deduced, as can the position of the base 81 of the scanner 80 relative to the axes XYZ, or the position of an object to which the scanner 80 is attached.

In the context of a robot arm it will be appreciated that the scanner 80 would be mounted on the robot arm, and used to determine the position relative to the XYZ axes of the part of the robot arm to which it is attached.

### 5.1 Calibration of the Steerable Light Ray Projector

The approach briefly described above requires that the scanner 80 is calibrated.

The abc system of axes is defined in a manner analogous to the way it was defined for the ray generator 10 of FIG. 2, by mounting conical receptors 14 (not shown in FIG. 8) onto the base 81. The centres of removable retroreflectors (SMRs) 15 placed into the receptors 14 define the abc system of axes associated with the scanner 80.

This system of axes abc defined by SMRs is real in the sense that is physically related to the base 81 of the scanner 80 and it can be related to other objects or systems of axes by conventional means such as a laser tracker. The abc system of axes can also be virtual in the sense that its position is unknown relative to the scanner 80 and depends on the calibration process of the steerable laser beam as is described below. Irrespective of whether the abc system of axes is real or virtual, its relationship to the base 81 of the scanner 80 is fixed.

The calibration process is analogous to that described earlier for the light ray projector 10 and illustrated in FIGS. 5a and 5b. Therefore reference is made to those figures bearing in mind that the light ray projector 10 is replaced by the scanner 80. The calibration steps are as follows: —
a) The laser scanner 40 locates the SMRs on the scanner 80 in a manner analogous to that shown in FIG. 5a for the ray projector 10 and thus identifies the abc system of axes associated in this case with the scanner 80.
b) The light ray 50 from the scanner 80 is switched on. With one rotation axis fixed, say at zero position, the other axis is rotated in steps, say every 10 degrees. At each position, with the light ray 50 remaining fixed, the calibration ring 30 in FIG. 5b is moved along the path of the laser beam in a point-to-point fashion and in such a way that the laser beam intersects the imaging sensor 22 on the calibration ring 30.
c) At each successive position of the calibration ring 30 its position is measured by the laser tracker 40 and related to the abc system of axes of the scanner 80. The rotation axis is then turned to another angular position and this process is repeated all over again.
d) Once the entire process is completed for one rotation axis, this axis is fixed, and the entire process is repeated for the other rotation axis. In this way the vector equations of the steerable light ray 50 are obtained relative to the abc system of axes associated with the scanner 80 and at discrete angular positions of each rotation axis. For a general position of the light ray 50 the equation of the path followed by the light ray 50 is obtained by interpolation between the adjacent calibrated positions and the encoder positions of each axis.

### 5.2 Operation of the Steerable Light Ray Projector

Referring again to FIG. 8, the scanner 80 may be steered manually or automatically, from CAD or other data, so as to transmit light rays 50 successively onto a plurality of the imaging sensors 22 on the base ring 20. The paths of the light rays 50 are known relative to the abc axes from the calibration described above, while the positions of the points of intersection P1-P5 are known relative to the XYZ axes. Hence the position of the abc system of axes, and so the position of any object to which the abc system of axes is rigidly attached, can be precisely determined with respect to the XYZ system of axes. This presumes that the scanner 80, or the object to which the scanner 80 is attached, does not move during the time it takes to direct the light rays successively onto the several imaging sensors 22. A minimum three intersections are required. Any more intersections provide redundancy, thus enhancing measurement accuracy.

The process described above is a direct position measurement process in which the abc system of axes is directly located with respect to the XYZ system of axes. An extension of this process is the indirect measurement process illustrated for the light ray generator 10 in FIG. 7. In this case the light ray generator 10 is replaced by the steerable single ray scanner 80.

In the first step, the scanner 80 directs the light ray 50 to sequentially intersect a number of visible imaging sensors 22 on the support frame 20. This process locates the abc system of axes relative to XYZ system of axes as described earlier. In the second step, the scanner 80 directs the light ray 50 to sequentially intersect a number of visible imaging sensors 22 on the secondary ring 60. This process locates the pqr system of axes relative to the scanner 80 and so the pqr system of axes to the XYZ system of axes.

Typically a robot arm includes a wrist mechanism that incorporates two different rotation axes, and then a flange to which tools may be attached. Hence the approach described in relation to the scanner 80 may instead be carried out by simply mounting a laser to such a flange of a robot. Alternatively a laser may be mounted on a position on the tool or on an object that is supported by the flange. A similar calibration would then be required, relative to axes abc that are fixed relative the base of the wrist mechanism. The conventional wrist mechanism can then be used to direct the laser beam successively on to three or more imaging sensors 22 on the base ring 20. The encoders associated with the wrist motors enable the paths of the light rays to be determined relative to the base of the wrist mechanism, and so this procedure enables the position of the base of the wrist mechanism to be monitored relative to the XYZ axes.

What is claimed:

1. An apparatus for making positional measurements of a robot arm, the apparatus comprising a light ray projector arranged to emit light rays along a multiplicity of distinct paths that are known relative to the projector, the projector being mounted on the robot aim; a support frame carrying a multiplicity of image sensors at fixed positions relative to the support frame; and means connected to the image sensors to determine the positions, relative to the support frame, at which light rays are incident on the image sensors, and hence to determine positional information of a system of axes associated with the projector relative to the support frame.

2. An apparatus as claimed in claim 1 wherein the light ray projector comprises a multiplicity of light sources.

3. An apparatus as claimed in claim 1 wherein the light ray projector emits more than 10 light rays.

4. An apparatus as claimed in claim 1 wherein the light ray projector emits a single ray of light, and is mounted on a scanning mechanism so that the light rays along the distinct paths are generated successively.

5. An apparatus as claimed in claim 1 wherein the image sensors comprise pixelated sensors comprising CCD or CMOS active-pixel sensing chips.

6. An apparatus as claimed in claim 5 wherein each image sensor comprises a plurality of adjacent imaging chips.

7. An apparatus as claimed in claim 1 wherein both the light ray projector and the support frame carry optical reference elements, or means to attach optical reference elements.

8. An apparatus as claimed in claim 7 wherein the optical reference elements are spherically mounted retroreflectors.

9. An apparatus as claimed in claim 1 also comprising a secondary support frame carrying a multiplicity of light sensors at fixed positions relative to the secondary support frame.

10. (canceled)

11. A method for making positional measurements, using a light ray projector arranged to emit light rays along a multiplicity of distinct paths that are known relative to the projector, and a support frame carrying a plurality of image sensors.

12. A method as claimed in claim 11 wherein the positional measurements are of the position of the light ray projector relative to a system of axes associated with the support frame.
